(19) United States
(12) Patent Application Publication
(10) Pub. No.: US 2021/0307490 A1
(43) Pub. Date: Oct. 7, 2021

(54) MULTI-FUNCTION BEAUTY DEVICE

(71) Applicant: Something High Electric (Xiamen) Company Inc., Xiamen (CN)

(72) Inventor: Chung-Chen Tsui, Xiamen (CN)

(21) Appl. No.: 16/899,573

(22) Filed: Jun. 11, 2020

(30) Foreign Application Priority Data
Apr. 3, 2020 (CN) 202020483563.1

(51) Int. Cl. A45D 40/26; A46B 13/02; A46B 15/00

(52) U.S. Cl. CPC A45D 40/265; A46B 13/023; A45D 2200/157; A46B 2200/106; A45D 2200/207; A46B 15/003

(57) ABSTRACT

A multi-function beauty device includes a functional assembly mounted on a casing. The casing includes a battery and a vibration assembly therein. An upper portion of the casing is formed with a fitting opening. The functional assembly includes a fitting part with a beauty accessory. The fitting part is inserted in the fitting opening in a top-down direction and positioned in the fitting opening. The beauty accessory extends out of the casing.

### BACKGROUND OF THE INVENTION

### 1. Field of the Invention

The present invention relates to a beauty device, and more particularly to a multi-function beauty device.

### 2. Description of the Prior Art

With the increase in age, the fast pace of life and the pressure of work, it is easy to cause people's skin to be aging and fatigued. Therefore, there are many skin care products on the market, such as electric massage beauty devices. A conventional beauty device includes a handle equipped with a massage head. Through the micro-vibration of the massage head, the facial massage is performed to achieve the purposes of skin tightening, lifting, and enhancing the metabolism of skin cells.

In general, the existing beauty device is installed with a massage head on the upper end of the handle. Each type of beauty device corresponds to a massage head. There are various massage heads for massagers, such as a single-head massage head, a double-head massage head, a T-shaped massage head and a Y-shaped massage head. A beauty device only provides a massage function. For daily beauty needs, it is necessary to purchase a variety of beauty tools, such as an eyebrow razor, a manicure knife, a nail file, and so on. Most of these beauty tools include handles and functional accessories (such as eyebrow razors, etc.). For those who care their health and beauty, they need to purchase many beauty products. This increases the cost and requires a large storage space, and is inconvenient to carry and use.

Accordingly, the inventor of the present invention has devoted himself based on his many years of practical experiences to solve these problems.

### SUMMARY OF THE INVENTION

The primary object of the present invention is to provide a multi-function beauty device, which can replace various functional assemblies according to different use requirements, so that the beauty device can be used for different purposes.

In order to achieve the above object, the present invention adopts the following technical solutions.

A multi-function beauty device comprises a functional assembly mounted on a casing. The casing includes a battery and a vibration assembly therein. An upper portion of the casing is formed with a fitting opening. The functional assembly includes a fitting part with a beauty accessory. The fitting part is inserted in the fitting opening in a top-down direction and positioned in the fitting opening. The beauty accessory extends out of the casing.

Preferably, the beauty accessory is one of a single-head massage head, a double-head massage head, an eyebrow razor, a nail file, a cold compress head and an eyelash brush.

Preferably, the fitting opening has a positioning groove in the upper portion of the casing. The positioning groove includes an upper opening on a top of the casing and a side opening on one side of the casing. The side opening communicates with the upper opening. The fitting part includes an insert plate. Two sides of the insert plate are provided with vertical positioning ribs. Two side walls of the positioning groove are provided with positioning rib grooves for the positioning ribs to be inserted and positioned therein. The beauty accessory disposed at an outer side of the insert plate is located outside the side opening.

Preferably, an upper cover for covering the top of the casing is provided on top of the fitting part. The upper cover is disposed on a top of the insert plate. After the insert plate is inserted and positioned in the positioning groove, the upper cover covers the top of the casing.

Preferably, a positioning ball is provided in the positioning groove relative to an inner wall of the side opening. A rear end of the positioning ball is connected to a spring located in the casing. An upper section of an inner side of the insert plate is recessed to form a semicircular engaging notch. The positioning ball is engaged in the engaging notch when the insert plate is inserted into the positioning groove. The positioning ball is disengaged from the engaging notch when the insert plate is pulled out of the positioning groove.

Preferably, two sides of the functional assembly are provided with stopping edges to lean against an outer side of the side opening, and the stopping edges are located at outer sides of the positioning ribs.

Preferably, a bottom of the insert plate is provided with a pushing surface, and the pushing surface is located outside the side opening.

Preferably, the beauty accessory is disposed on a connecting plate, and the connecting plate is connected to the outer side of the insert plate.

Preferably, a holder is provided in the casing. The battery and the vibration assembly are mounted to the holder. The vibration assembly includes a motor and an eccentric member sleeved on a rotating shaft of the motor. A printed circuit board is provided in the casing and is in electrical connection with the motor and the battery.

Preferably, the beauty accessory is an eyelash brush. The eyelash brush is provided with a heating wire for heating bristles of the eyelash brush. One side of the fitting part, facing the fitting opening, is provided with at least one metal piece in electrical communication with the heating wire. The casing is provided with a metal ring in the upper portion of the casing. The metal ring is electrically connected to the printed circuit board. The metal piece is in contact with the metal ring to achieve electrical conduction when the fitting part is inserted into the fitting opening.

In the beauty device of the present invention, the fitting part of each functional assembly is movably coupled to the fitting opening of the casing, which is beneficial for replacement of different functional assemblies with different beauty accessories. The beauty device can be used for different purposes.

### BRIEF DESCRIPTION OF THE DRAWINGS

FIG. 1 is a perspective view of the present invention in an assembled state;

FIG. 2 is a schematic view showing that the functional assembly is taken out from the casing of the present invention (wherein the beauty accessory is an eyebrow razor);

FIG. 3 is an exploded view of the present invention;

FIG. 4 is a longitudinal sectional view of FIG. 1;

FIG. 5 is a longitudinal sectional view of FIG. 2;

FIG. 6 is a top view of the casing of the present invention;

FIG. 7 is a cross-sectional view of the functional assembly of FIG. 2;

FIG. 8 is an exploded view of the functional assembly of FIG. 2;

FIG. 9 is a schematic view of the beauty accessory that is an eyebrow razor;

FIG. 10 is an exploded view of the beauty accessory that is an eyebrow razor;

FIG. 11 is a schematic view of the beauty accessory that is a single-head massage head;

FIG. 12 is a schematic view of the beauty accessory that is a double-head massage head;

FIG. 13 is a schematic view of the beauty accessory that is a nail file;

FIG. 14 is a schematic view of the beauty accessory that is a cold compress head; and

FIG. 15 is a schematic view of the beauty accessory that is an eyelash brush.

### DETAILED DESCRIPTION OF THE PREFERRED EMBODIMENTS

Embodiments of the present invention will now be described, by way of example only, with reference to the accompanying drawings.

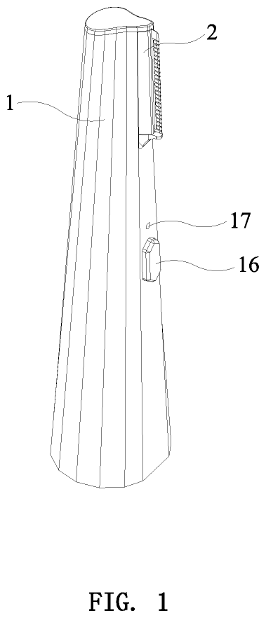

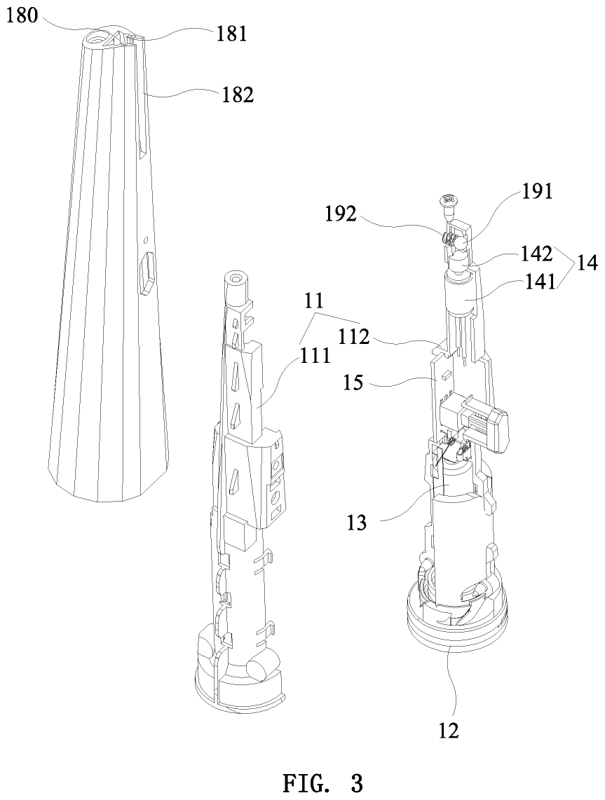

With reference to FIGS. 1 to 3, the present invention discloses a multi-function beauty device, comprising a functional assembly 2 mounted on a casing 1. The functional assembly 2 of the present invention is mainly used for beauty functions. For the casing 1 to be held better, the casing 1 has a truncated cone shape, with a narrow upper portion and a wide lower portion. The outer surface of the casing 1 forms an inclined surface gradually expanding in a top-down direction. For the beauty device to have a vibration effect, a battery 13 and a vibration assembly 14 are provided in the casing 1. As shown in the figures, a holder 11 is provided in the casing 1. The holder 11 is composed of a left holder 111 and a right holder 112. The bottom of the casing 1 is provided with a bottom cover 12. The battery 13 and the vibration assembly 14 are mounted to the holder 11. Wherein, the vibration assembly 14 may include a motor 141 and an eccentric member 142 sleeved on a rotating shaft of the motor 141. A printed circuit board 15 is provided in the casing 1 and is in electrical connection with the motor 141 and the battery 13. A button 16 and a light guide 17 are provided on the casing 1. The light guide 17 functions as an indicator light. The button 16 and the light guide 17 are electrically connected to the printed circuit board 15, respectively. They can be powered by a single dry battery or a rechargeable battery. When in use, by pressing the button 16, the circuit is connected, the motor 141 is energized to work and drive the functional assembly to vibrate, the device works, and the indicator light is lit at the same time. The button 16 is pressed to bounce up, the circuit is disconnected, and the device does not work.

With reference to FIGS. 1 to 8, in the present invention, an upper portion of the casing 1 is formed with a fitting opening 18. The functional assembly 2 includes a fitting part 21 with a beauty accessory. As shown in FIGS. 1 to 8, the beauty accessory on the functional assembly 2 is an eyebrow razor 22. When in use, the fitting part 21 is inserted in the fitting opening 18 in a top-down direction and positioned in the fitting opening 18. The eyebrow razor 22 extends out of the casing 1. Then, the user holds the casing 1 to perform eyebrow trimming operation. Wherein, the fitting opening 18 has a positioning groove 180 in the upper portion of the casing 1. The positioning groove 180 includes an upper opening 181 on the top of the casing 1 and a side opening 182 on one side of the casing 1. The side opening 182 communicates with the upper opening 181. The fitting part 21 includes an insert plate 210. At least one vertical positioning rib 211 is provided on either side of the insert plate 210. In this embodiment, two positioning ribs 211 are provided on two sides of the insert plate 210. Two side walls of the positioning groove 180 are correspondingly provided with positioning rib grooves 183 for the positioning ribs 211 of the insert plate 210 to be inserted and positioned therein. When the insert plate 210 is inserted into the positioning groove 180, the fitting part 21 is fitted in the fitting opening 18 of the casing 1 through the positioning action of the two positioning ribs 211, and the eyebrow razor 22 at the outer side of the insert plate 210 is located outside the side opening 182 for use.

Furthermore, an upper cover 23 for covering the top of the casing 1 is provided on top of the fitting part 21. The upper cover 23 corresponds in shape to the top of the casing 1. The upper cover 23 is disposed on the top of the insert plate 210. After the insert plate 210 is inserted and positioned in the positioning groove 180, the upper cover 23 covers the top of the casing 1 to beautify the casing 1.

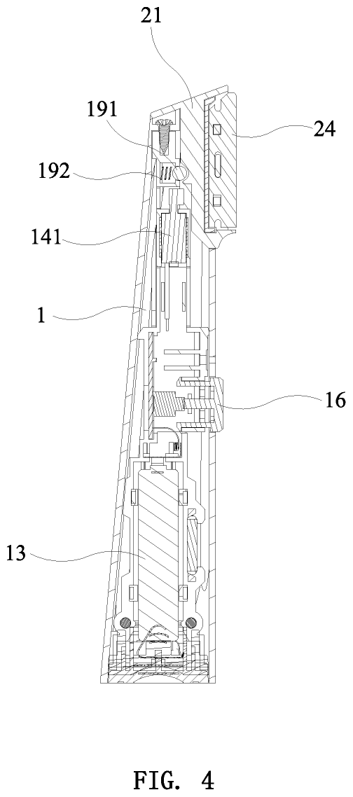

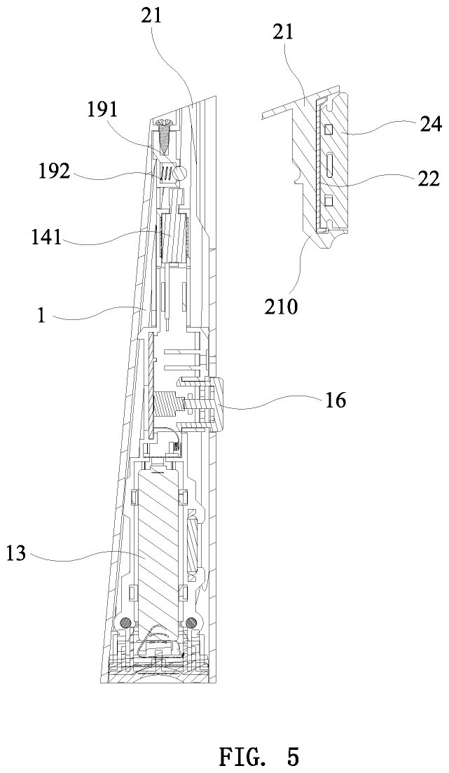

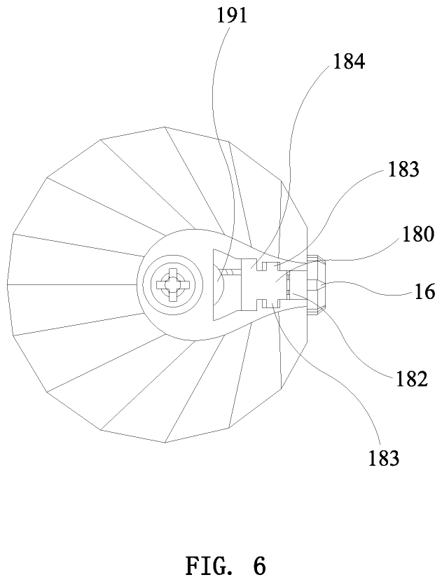

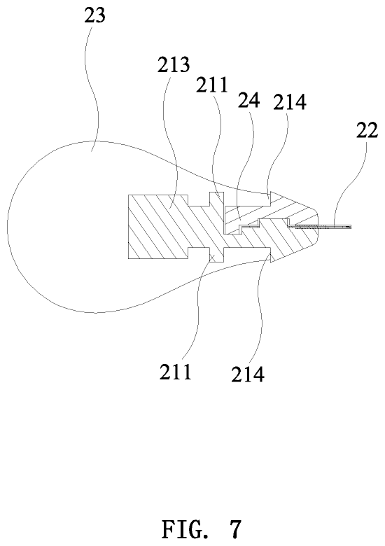

As shown in FIG. 4 and FIG. 5, for the fitting part 21 to be positioned better, a positioning ball 191 is provided in the positioning groove 180 relative to the inner wall of the side opening 182, and the rear end of the positioning ball 191 is connected to a spring 192 located in the casing 1. Besides, the upper section of the inner side of the insert plate 210 is recessed to form a semicircular engaging notch 212. The positioning ball 191 is engaged in the engaging notch 212 when the insert plate 210 is inserted into the positioning groove 180. On the contrary, when the insert plate 210 is pulled out of the positioning groove 180, the positioning ball 191 is disengaged from the engaging notch 212. Through the positioning ball 191, the insert plate 210 can be positioned in the lateral direction, so that the fitting part 21 can be positioned in the positioning groove 180 more stably. The inner side of the insert plate 210 is provided with an extension slab 213 extending toward the inner wall of the positioning groove 180. The engaging notch 212 is disposed at the lower end of the extension slab 213. For the extension slab 213, in the positioning groove 180, the inner side of the positioning rib groove 183 is formed with an inner groove 184 for the extension slab 213 to be inserted therein (as shown in FIG. 6 and FIG. 7).

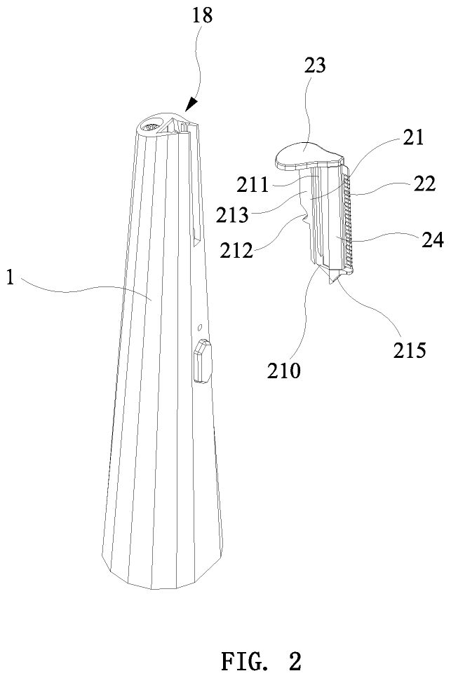

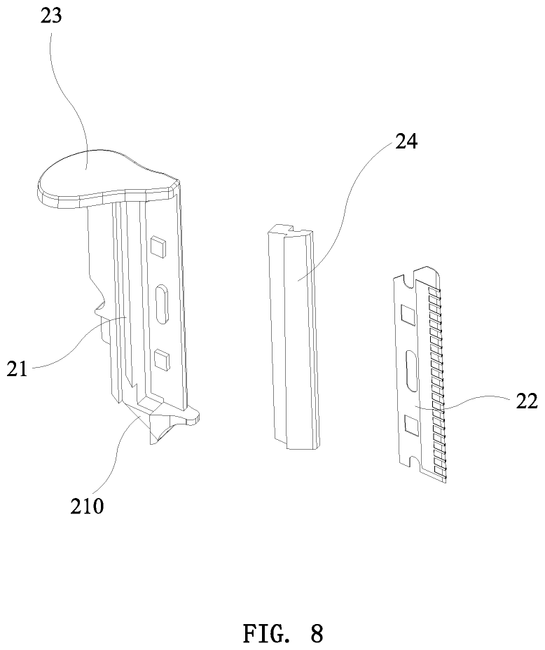

Two sides of the functional assembly 2 are provided with stopping edges 214 to lean against the outer side of the side opening 182. The stopping edges 214 are located at the outer sides of the positioning ribs 211. The stopping edges 214 may be directly disposed on the insert plate 210, or may be disposed on the inner sides of a connecting plate 24 (as shown in FIG. 7 and FIG. 8). When the insert plate 210 is inserted from the upper opening 181 in a top-down direction, the stopping edges 214 lean against the two sides of the side opening 182 to slide down. As shown in FIG. 2 and FIG. 4, the bottom of the insert plate 210 is provided with a pushing surface 215. The pushing surface 215 is located under the stopping edges 214 and located outside the side opening 182. The pushing surface 215 is in the form of an inclined arc-shaped surface. In use, the fitting part 21 can be conveniently pushed out of the positioning groove 180 with the user's finger through the pushing surface 214.

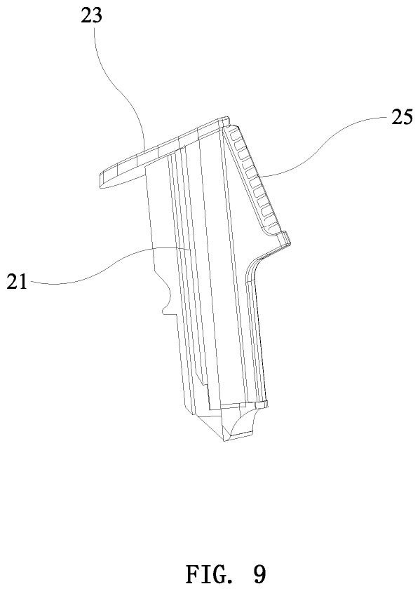

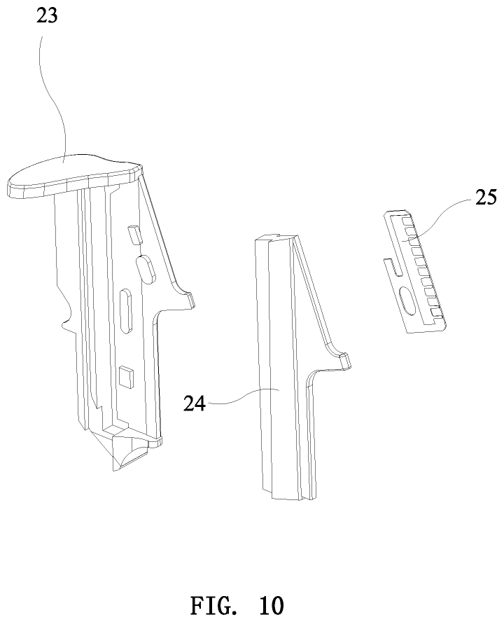

As for the beauty accessory on the fitting part 21, as shown in FIG. 2, FIG. 7 and FIG. 8, the eyebrow razor 22 is disposed on a connecting plate 24, and the connecting plate 24 is connected to the outer side of the insert plate 210. The connecting plate 24 is connected to the insert plate 210 by a snap-fit connection. The eyebrow razor 22 is connected to the connecting plate 24 by a snap-fit connection, and then the connecting plate 24 is fixed to the insert plate 210 by ultrasonic welding, so that the eyebrow razor 22 is fixed on the connecting plate 24, thereby forming an integral functional assembly. As shown in FIG. 9 and FIG. 10, the beauty accessory is a blade 25 of the eyebrow razor. The blade 25 is disposed on a connecting plate 24, and the connecting plate 24 is connected to the insert plate 210 to form a functional assembly.

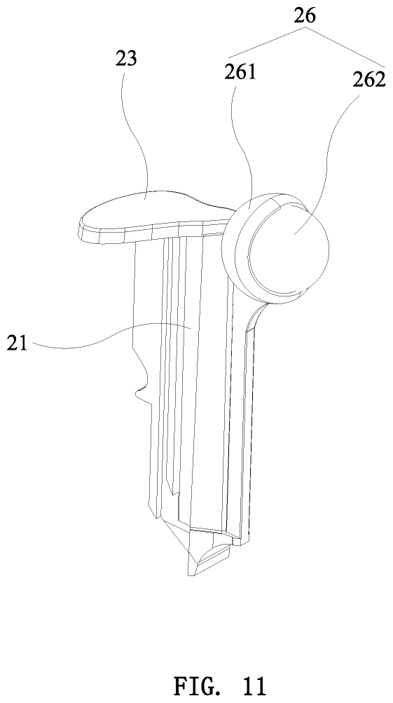

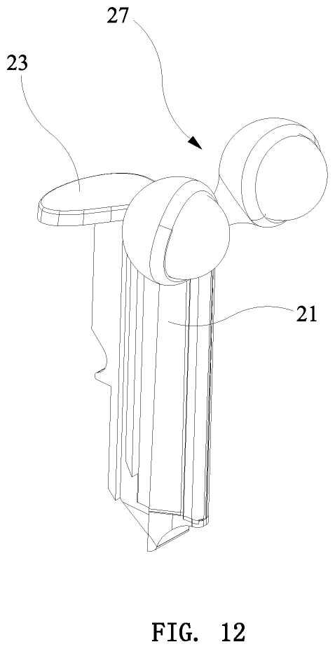

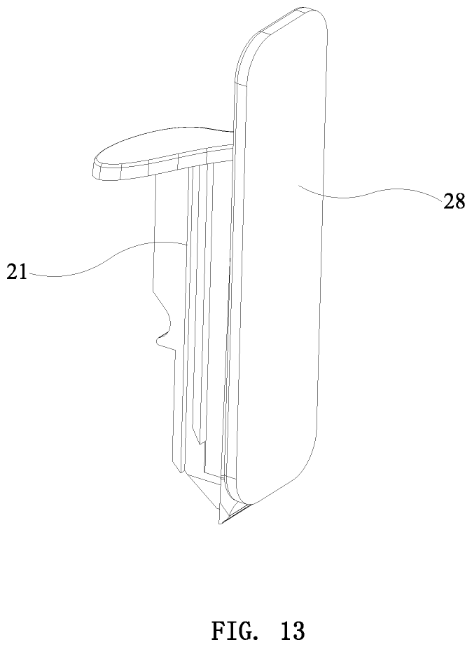

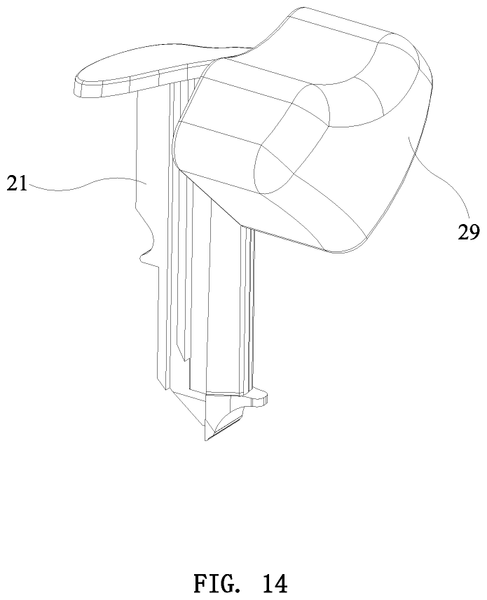

With reference to FIGS. 11-15, the beauty accessory may be a single-head massage head 26, a double-head massage head 27, a nail file 28, a cold compress head 29, an eyelash brush 30, other different types of massage heads, or the heads of other tool heads. The beauty accessory may be directly formed on the side of the fitting part 21 by injection molding, or may be directly fixed on the fitting part 21 by other connections. As shown in FIG. 11, the side of the insert plate 210 of the fitting part 21 is formed with a coupling portion 261 of the single-head massage head 26, and a massage sphere 262 is fitted in the coupling portion 261. In use, after the button 16 is pressed to energize, the single-head massage head 26 vibrates and is attached to the user's face for massage. Similarly, as shown in FIG. 12, the double-headed massage head 27 may be formed on the fitting part 21. As shown in FIG. 13, the beauty accessory is a nail file 28. As shown in FIG. 14, the beauty accessory is a cold compress head 29 for cold compress. A liquid chamber is formed inside the cold compress head 29. The back of the cold compress head 29 is formed with an opening that can be closed to facilitate the injection of a cooling liquid.

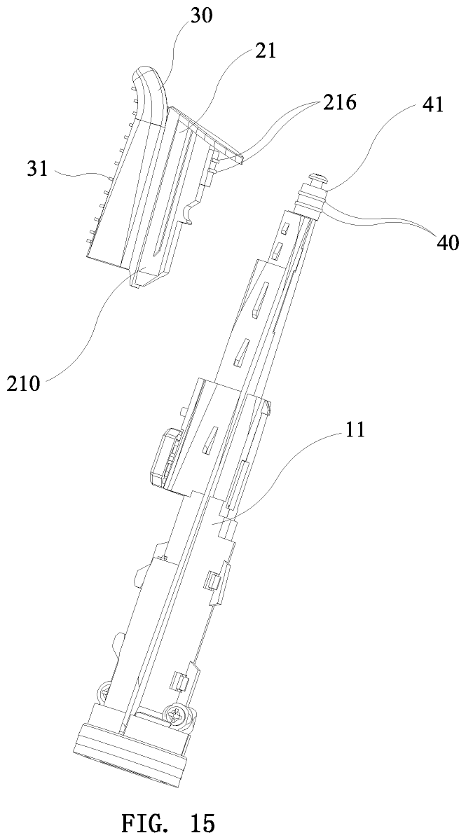

As shown in FIG. 15, the beauty accessory may be an eyelash brush 30. The eyelash brush 30 is disposed on the outer side of the insert plate 210. The eyelash brush 30 is provided with bristles (not shown). The eyelash brush 30 is provided with a heating wire 31 for heating the bristles. One side of the fitting part 21, facing the fitting opening 18, is provided with at least one metal piece 216 in electrical communication with the heating wire 31. In this embodiment, two metal pieces 216 are provided on the inner side of the insert plate 210. The casing 1 is provided with a metal ring 40 in the upper portion of the casing 1. The metal ring 40 is electrically connected to the printed circuit board 15. A guide post 41 is provided at the upper end of the holder 11. The metal ring 40 is disposed on the guide post 41. The metal ring 40 corresponds to the metal piece 216. When the fitting part 21 is inserted into the fitting opening 18, the metal piece 216 as a metal contact is in contact with the metal ring 40 to achieve electrical conduction. In use, as long as the button 16 is pressed, the heating wire 31 is heated to quickly heat the bristles, making the bristles soft and easy to be dipped in mascara, so that the application effect is better.

When in use, the beauty device provided by the present invention can be used by replacing different functional assemblies. The fitting part 21 of each functional assembly is inserted into the fitting opening 18, thereby realizing different functions and greatly improving the use of the beauty device.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A multi-function beauty device, comprising a functional assembly mounted on a casing, the casing including a battery and a vibration assembly therein; an upper portion of the casing being formed with a fitting opening, the functional assembly including a fitting part with a beauty accessory, the fitting part being inserted in the fitting opening in a top-down direction and positioned in the fitting opening, the beauty accessory extending out of the casing.

2. The multi-function beauty device as claimed in claim 1, wherein the beauty accessory is one of a single-head massage head, a double-head massage head, an eyebrow razor, a nail file, a cold compress head and an eyelash brush.

3. The multi-function beauty device as claimed in claim 1, wherein the fitting opening has a positioning groove in the upper portion of the casing, the positioning groove includes an upper opening on a top of the casing and a side opening on one side of the casing, the side opening communicates with the upper opening, the fitting part includes an insert plate, two sides of the insert plate are provided with vertical positioning ribs, two side walls of the positioning groove are provided with positioning rib grooves for the positioning ribs to be inserted and positioned therein, and the beauty accessory disposed at an outer side of the insert plate is located outside the side opening.

4. The multi-function beauty device as claimed in claim 3, wherein an upper cover for covering the top of the casing is provided on top of the fitting part, the upper cover is disposed on a top of the insert plate, after the insert plate is inserted and positioned in the positioning groove, the upper cover covers the top of the casing.

5. The multi-function beauty device as claimed in claim 3, wherein a positioning ball is provided in the positioning groove relative to an inner wall of the side opening, a rear end of the positioning ball is connected to a spring located in the casing, an upper section of an inner side of the insert plate is recessed to form a semicircular engaging notch, the positioning ball is engaged in the engaging notch when the insert plate is inserted into the positioning groove, and the positioning ball is disengaged from the engaging notch when the insert plate is pulled out of the positioning groove.

6. The multi-function beauty device as claimed in claim 3, wherein two sides of the functional assembly are provided with stopping edges to lean against an outer side of the side opening, and the stopping edges are located at outer sides of the positioning ribs.

7. The multi-function beauty device as claimed in claim 3, wherein a bottom of the insert plate is provided with a pushing surface, and the pushing surface is located outside the side opening.

8. The multi-function beauty device as claimed in claim 3, wherein the beauty accessory is disposed on a connecting plate, and the connecting plate is connected to the outer side of the insert plate.

9. The multi-function beauty device as claimed in claim 1, wherein a holder is provided in the casing, the battery and the vibration assembly are mounted to the holder, the vibration assembly includes a motor and an eccentric member sleeved on a rotating shaft of the motor, and a printed circuit board is provided in the casing and is in electrical connection with the motor and the battery.

10. The multi-function beauty device as claimed in claim 9, wherein the beauty accessory is an eyelash brush, the eyelash brush is provided with a heating wire for heating bristles of the eyelash brush, one side of the fitting part, facing the fitting opening, is provided with at least one metal piece in electrical communication with the heating wire, the casing is provided with a metal ring in the upper portion of the casing, the metal ring is electrically connected to the printed circuit board, and the metal piece is in contact with the metal ring to achieve electrical conduction when the fitting part is inserted into the fitting opening.
